(19) United States
(12) Patent Application Publication
(10) Pub. No.: US 2015/0089053 A1
(43) Pub. Date: Mar. 26, 2015

(54) DYNAMICALLY SCRIPTABLE IP TRAFFIC LOAD BALANCING FUNCTION

(71) Applicant: RIFT.io Inc., Burlington, MA (US)

(72) Inventors: Matthew Harper, Salem, NH (US); Timothy Mortsolf, Amherst, MA (US)

(21) Appl. No.: 14/483,208

(22) Filed: Sep. 11, 2014

Related U.S. Application Data
(60) Provisional application No. 61/882,047, filed on Sep. 25, 2013.

(51) Int. Cl. H04L 12/803; H04L 12/26

(52) U.S. Cl. CPC H04L 47/125; H04L 43/0805
USPC 709/224

(57) ABSTRACT

A dynamically-scriptable load balancer including a packet input port, a packet output port, a dynamically scriptable load balancing engine, and an application interface for loading a load balancing script into the dynamically scriptable load balancing engine.

### BACKGROUND

The present invention relates to network processing devices including load balancers containing IP packet processing engines.

When the IP protocol architecture was defined, two general categories of computer networking nodes were defined: IP hosts and IP routers. These terms are defined in IETF RFC 1122:

“A host computer, or simply ‘host,’ is the ultimate consumer of communication services. A host generally executes application programs on behalf of user(s), employing network and/or Internet communication services in support of this function. An Internet host corresponds to the concept of an ‘End-System’ used in the OSI protocol suite . . . An Internet communication system consists of interconnected packet networks supporting communication among host computers using the Internet protocols. The networks are interconnected using packet-switching computers called ‘gateways’ or ‘IP routers’ by the Internet community . . . ”

Over time, commercial IP router vendors have integrated many services beyond those originally envisioned in IETF RFC 1812 (Requirements for IP Version 4 Routers). For example, specialized network devices (e.g. IP Firewalls and HTTP load balancers) have been developed to enforce network policies on IP traffic flowing through the network according to the network operator's requirements. These enhanced “routers” provide a set of configurable packet processing functions across protocol layers 2-7.

Applications running on hosts do not typically interact directly with the IP routers interconnecting them unless the application itself is a routing protocol or router network management application. However, there are some well-known examples of a host application directly interacting with the intermediate routers as seen with protocols: IETF Resource Reservation Protocol (RSVP), SOCKS5 (RFC 1928), and OpenFlow. Nevertheless, the common theme in each of these is that the functions/services provided by the IP routing device are built-in and the application is simply configuring the predefined functions that the device provides.

### SUMMARY

In one embodiment, the invention provides a dynamically-scriptable load balancer including a packet input port, a packet output port, a dynamically scriptable load balancing engine, and an application interface for loading a load balancing script into the dynamically scriptable load balancing engine.

In another embodiment, the invention provides a method for dynamically controlling a load balancer. The method includes the steps of providing a dynamically-scriptable load balancer having a packet input port, a packet output port, a dynamically scriptable load balancing engine, and an application interface; and loading a load balancing script into the scriptable load balancing engine through the application interface.

In yet another embodiment, the invention provides a system for dynamically controlling a load balancer. The system includes a dynamically-scriptable load balancer including a packet input port, a packet output port, a dynamically scriptable load balancing engine, an application interface, and a controller in communication with the packet input port, the packet output port, the dynamically scriptable load balancing engine, and the application interface. The controller is configured to load a load balancing script into the scriptable load balancing engine through the application interface.

Other aspects of the invention will become apparent by consideration of the detailed description and accompanying drawings.

### BRIEF DESCRIPTION OF THE DRAWINGS

FIG. 1 shows a diagram of a dynamically-scriptable router according to embodiments of the invention.

FIG. 2 shows a diagram of a scriptable packet processing engine running as a user-space program on top of a Linux kernel.

FIG. 3 shows a diagram of a dynamically-scriptable load balancer according to embodiments of the invention.

FIG. 4 shows a diagram of a dynamically-scriptable load balancer according to embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

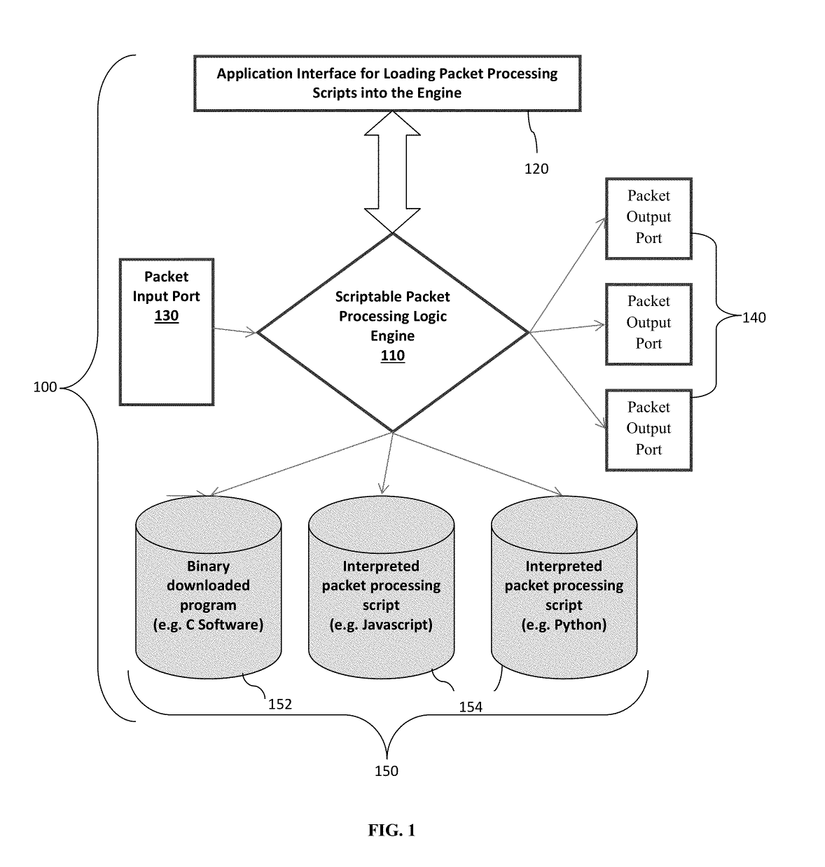

In various embodiments the invention includes one or more applications which arbitrary extend the behavior of an IP router by dynamically inserting one or more packet-processing scripts into the forwarding plane of a router as shown in the diagram of FIG. 1.

FIG. 1 shows a diagram of a dynamically-scriptable router 100 according to embodiments of the invention. The router 100 includes a scriptable packet processing engine 110 having an application interface 120 (sometimes referred to as an “API”), at least one packet input port 130, and one or more packet output ports 140. The application interface 120 facilitates loading of packet processing scripts 150 into the packet processing engine 110 and can also transfer data such as debugging and profiling information obtained from executing scripts. The packet processing scripts 150 may include a binary downloaded program 152 (e.g. software written in languages such as C or C#) or an interpreted packet processing script 154 (e.g. written in Java, Javascript, or Python, or derivatives of scripted languages such as Cython and Jython).

In use, the scriptable packet processing engine 110 executes a program which provides extensible access to the application interface 120 using a network protocol such as TCP/IP such that an API user's computer can gain access to the application interface 120, for example over a wired or wireless network. Packets entering the router 100 via I/O (e.g. packet input ports 130 and packet output ports 140) may be managed by the scriptable packet processing engine 110 itself or the packets may be managed by TCP/IP services provided by the operating system of the user's computer (which uses ports managed by the I/O itself). Within the TCP/IP session, application interface 120 commands are exchanged which extend the functions of the scriptable packet processing engine 110, provide instructions on how to treat packets, and provide management information. The remote API user's program is typically running on a remote host, but it is also possible for the API user to be running on the same physical machine that is running the scriptable packet processing engine 110. Scripts can be updated by sending network packets containing a script to the API or using a CLI or GUI to the API to provide manual scripts written by a user or derived from another script written by a user.

The router 100 may include a controller (including, e.g., a microprocessor) in communication with the packet input port, the packet output port, the dynamically scriptable packet processing engine, and the application interface. In various embodiments, the controller is configured to carry out the operations of the router 100 as disclosed herein.

The packet input ports 130 and packet output ports 140 can be physical devices (e.g. Ethernet port), logical devices (e.g. VLAN on a physical Ethernet port), or virtual logical devices (virtual Ethernet driver associated with a VSWITCH between virtual machines running on a general purpose computing platform), and a given router 100 may include combinations of types of packet input ports 130 and packet output ports 140. The number of physical packet input ports 130 and packet output ports 140 on a given router 100 is generally a hundred or less, however, each physical port can support thousands of logical ports (e.g. VLANS). In various embodiments, one or more packet input ports 130 and packet output ports 140 may be part of link aggregation groups (LAGs).

The scriptable packet processing engine 110 can be embodied as an add-on software function to a traditional hardware-based IP packet router, software running on a general purpose computing platform (e.g. blade server), or as a software module extending a virtual hardware switch (VSWITCH) between virtual systems. When running on a general purpose computing platform, the software would typically be run in userspace along with userspace I/O device drivers. The router 100 also includes a microprocessor and memory that are in communication with the scriptable packet processing engine 110.

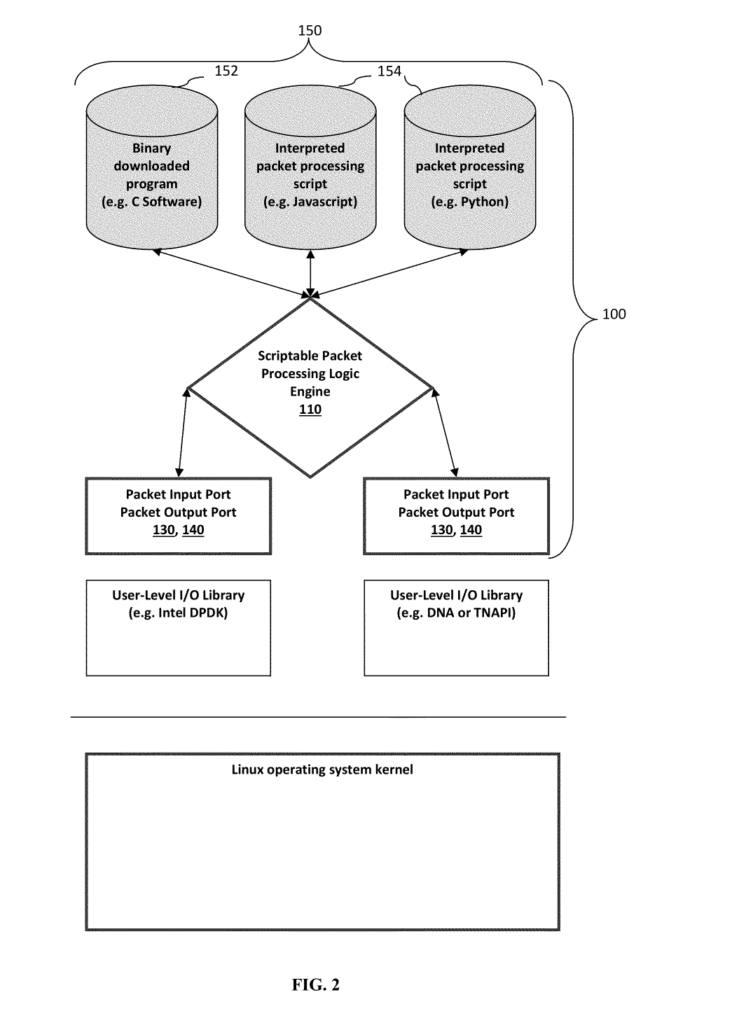

For example, FIG. 2 shows the scriptable packet processing engine 110 running as a user-space program on top of a Linux kernel. The user-space located engine 110 is directly managing/programming the I/O hardware, thus completely bypassing the kernel as packets flow through it.

The scriptable packet processing engine 110 is dynamically programmed at runtime (by one or more independent application programs) and supports multiple simultaneous independent packet processing scripts. The scripts are executed in a prioritized fashion (as requested by the applications themselves and/or as assigned by the system). A single input packet may be serviced by a variable number of scripts. For example, one application might install a script that makes copies of every packet that matches a specific UDP destination port and sends the copy over a TCP session back to the application. A second script might perform a traffic classification and shaping operation on every packet that arrives on a specific port. A third program might perform deep packet inspection processing and tag the packet (or corresponding traffic flows) with metadata that can be used by a later-executed script to record statistics, etc.

The packet processing scripts loaded by the application interface 120 can be defined in either a compiled language (e.g. software written in languages such as C or C#) or an interpreted scripting language such as Python, Java, or Javascript, or derivatives of scripted languages such as Cython and Jython. One advantage of using an interpreted language is that if a script is installed that contains a programming fault, the scriptable packet processing framework will catch the exception and recover gracefully (e.g. terminate the script) without affecting other scripts or packets. For performance, a JIT (Just-in-time) compilation engine can be applied to optimize the interpreted scripts. A second advantage is that these scripts can work across all ranges of devices that support this feature without any changes to the interpreted scripts. Binary compiled programs do not offer this advantage and must generally be recompiled for different hardware devices. Any hardware or software device that supports the interpreted scripting language would be able to use the script without change regardless of the underlying hardware. A third advantage is that these interpreted scripts are often easier for application developers to write, providing application developers with a resource to develop network scripts that run on devices they commonly cannot program. In addition, interpreted packet processing scripts can gain access to direct hardware I/O from userspace.

Compared to existing routers for which control is limited to setting of parameters, the dynamically-scriptable router 100 disclosed herein is fully programmable and can be configured to perform arbitrary functions using arbitrary lists of instructions. A particular script may add a new behavior to the router 100, for example creating a new event such as the transmission of a signaling packet when a certain type of timeout occurs. Furthermore, the arbitrary functions of the dynamically-scriptable router 100 disclosed herein are inserted at run-time, in contrast to the pre-programmed functions that are hardwired into known routers. Finally, the scriptable packet processing engine 110 allows scripts to pass information about a given packet to subsequent scripts (e.g. a retransmission packet) and to also modify the sequence of scripts to be applied to each packet.

For the dynamically-scriptable router 100, a manufacturer or vendor of such a router supplies an environment in a programmable system and each user supplies the functionality they need by providing arbitrarily complex programs to the scriptable packet processing engine 110 via the application interface 120. Thus, instead of being limited to providing parameters for a few preordained functions as on known routers, a user can make use of the full array of commands available in known programming (e.g. C or C#) or scripting (e.g. Java, Javascript or Python, or derivatives such as Cython and Jython) languages. In addition, in various embodiments a script may add functionality to the router 100 by adding new primitives.

In addition to being able to perform adding arbitrary functions, the router 100 disclosed herein is stateful and includes memory that can be read and written to by the scripts. With this capability, the scripts that are run on the packet processing engine 110 can perform functions on the packets that require knowledge of previous packets. While some known systems have a limited amount of memory, e.g. a counter to gather statistics, this memory is for specific uses and is not made available for general use, and therefore is not equivalent to a stateful system. Thus, known routers, which are stateless, cannot take into account packet information which came through the router previously. For example, a http request might have its URL split between two packets but a stateless router would be unable to act on the whole URL since the router would be unable to store the first part of the URL until the second part became available.

While known packet processing engines have software that is coded into the device, this software cannot be used to introduce new protocols and the device cannot be reconfigured at runtime. For example, a packet processing program that provides Ethernet encapsulation and IP header encapsulation cannot be simply reconfigured (other than providing a new software image while the device is offline) to process IPSEC header encapsulation. However, with a scriptable packet processing engine such as that disclosed herein, new packet processing protocols can be provided with the existing software images and without requiring offline reconfiguration or addition of new firmware, by merely reconfiguring the existing software with a script introduced at runtime and without interrupting packet forwarding. These scripts can be changed in real-time to quickly update the packet processing protocols of the platform using a variety of scriptable and compiled programming languages, as discussed above.

Accordingly, the following are some examples of services that can be provided by scripts running in the packet processing engine 110:
Perform protocol decoding of a packet arriving on an input port, perform lookups in existing state tables, update state tables, modify the packet by adding/removing/updating headers or the packet payload, and then forward the resulting packet to an output port
Make a copy of a packet arriving on an input port to an output port
Classify traffic into a category and apply traffic policing/shaping
Scan payload of TCP session vs. known patterns
Perform DPI analysis on packets and tag with the pdu and flows with metadata
Collect various statistics for export
Perform protocol-specific load balancing (e.g. GTP-C decoding) and tunneling of traffic for subsequent processing
Applying/Removing an IP tunneling encapsulation (e.g. MPLS, IPSEC, L2TP, GRE) to traffic matching a pattern
Perform line rate test tool packet generation and packet validation
Perform policy-based IP forwarding
Apply a packet-filtering operation
Perform IP-reassembly
Process packets following IP-reassembly
Tunnel traffic matching specific patterns to a remote application process (or operating system kernel) for additional processing

In other embodiments, the dynamically scriptable packet processing engine 110 can be programmed to collect debugging and profiling information from executing scripts and to return this information via the application interface 120. Scripts (also called plugins) inserted into the packet processing engine 110 can run in both single-threaded mode of operation with a single thread allocated to processing the packets, or a multi-threaded mode of operation that allows multiple threads to concurrently process packets in parallel by any individual running script.

Dynamically-Scriptable Load Balancer

As the Internet has evolved, both the scale and sophistication of the services being offered by it have increased dramatically. The simplicity and advantages of having a single well-known IP Host (or a small number of IP Hosts) providing a useful service (e.g. Yahoo's web portal) have not diminished. However, the inability of a single physical computer to provide these types of services at a large scale and with sufficient reliability has necessitated the development of a new class of network devices called IP load balancers. Load balancers are devices that distribute network or application traffic to a pool of IP hosts. Greatly improved performance and reliability is achieved by using a pool of hosts rather than a single host to provide services.

Load balancers are generally categorized by the IP protocol layer used to segregate IP traffic flows, the common distinction being: Layer3, Layer4, or Layer7. Many commercial (Cisco, Juniper, F5) and public-domain (Apache, Zen) load balancer implementations exist. Load balancers have been developed for many application protocols. In addition to standalone load balancers, many commercial networking devices (e.g. firewalls, Home-Agents, GGSN, PDSN, etc.) contain embedded load-balancers which internally distribute application traffic to multiple processing elements (typically CPUs) to address scalability/redundancy concerns.

As a general rule, load balancers are only able to handle traffic types that have been built into their hardware (or software). API support by load balancers is generally non-existent or limited. The most common API support by a load balancer would be a monitoring service so that the load balancer could check to see if a particular host was available to receive traffic.

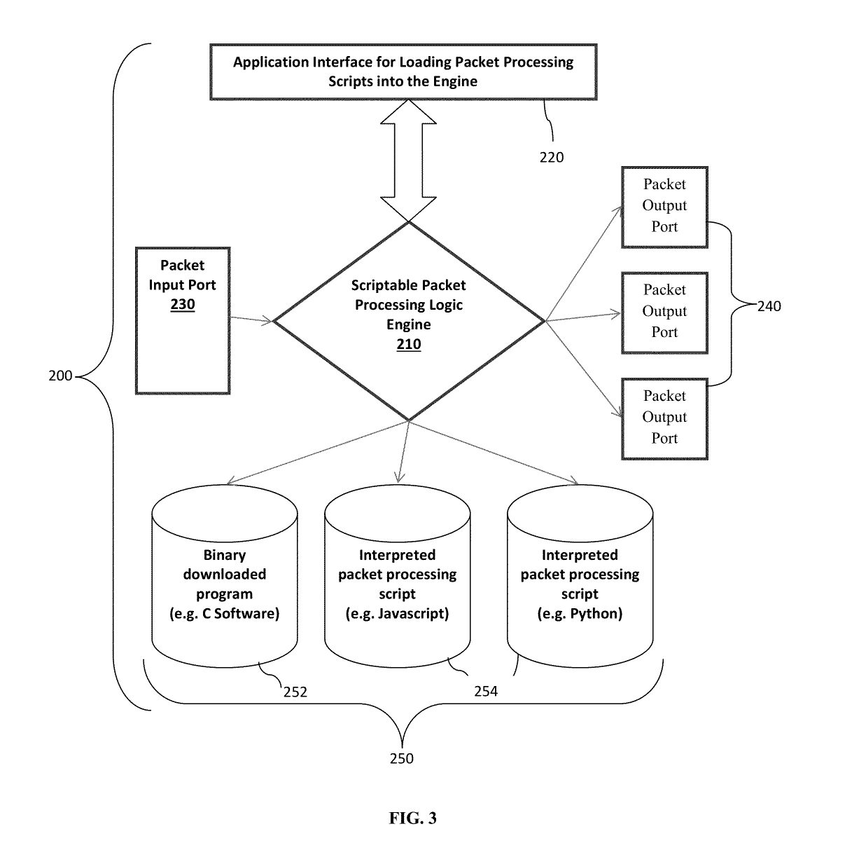

Thus in one particular embodiment, the dynamically-scriptable router 100 can function as a dynamically-scriptable load balancer 200. That is, a script 250 may be loaded into the scriptable packet processing engine 110 such that the router 100 performs load balancing functions. The dynamically-scriptable load balancer 200 provides an application interface (API) 210 to dynamically extend load balancing functions. As with the dynamically-scriptable router 100, the load balancing functions are downloaded to the dynamically-scriptable load balancer 200 via the API 210 as either interpreted programming scripts or binary programming extensions. The functionality of the dynamically-scriptable load balancer 200 can be arbitrarily extended by using an API to dynamically insert new load balancing script(s) into the forwarding plane of the Load Balancer as shown in FIG. 3.

FIG. 3 shows a diagram of a dynamically-scriptable load balancer 200 according to embodiments of the invention. The load balancer 200 includes a scriptable load balancing engine 210 having an application interface 220 (sometimes referred to as an “API”), at least one packet input port 230, and one or more packet output ports 240. The application interface 220 facilitates loading of load balancing scripts 250 into the load balancing engine 210 and can also transfer data such as debugging and profiling information obtained from executing scripts. The load balancing scripts 250 may include a binary downloaded program 252 (e.g. software written in languages such as C or C#) or an interpreted load balancing script 254 (e.g. written in Java, Javascript, or Python, or derivatives of scripted languages such as Cython and Jython).

Packet input ports 230 and packet output ports 240 can be physical devices (e.g. Ethernet port), logical devices (e.g. VLAN on a physical Ethernet port), or virtual logical devices (virtual Ethernet driver associated with a VSWITCH between virtual machines running on a general purpose computing platform), and a given load balancer 200 may include combinations of types of packet input ports 230 and packet output ports 240. The number of physical packet input ports 230 and packet output ports 240 on a given load balancer 200 is generally a hundred or less, however, each physical port can support thousands of logical ports (e.g. VLANS).

In various embodiments the load balancer 200 is part of a system which can support multiple concurrent application interface 220 instances and track all resources allocated against each such instance (e.g. installed scripts, flow-state records, statistics blocks). Among other features, the system can gracefully recover in the event of a failure. For example, if an application program which is using an instance of an application interface 220 available over a network loses communication with the scriptable load balancer 200, the load balancer 200 can be configured to automatically disable or remove the resources (e.g. installed scripts, flow-state records, statistics blocks) allocated to that instance of the application interface 220.

As with the scriptable packet processing engine 110 described above, the load balancing engine 210 can be embodied as an add-on software function to a traditional hardware-based IP packet router, software running on a load balancer, software running on a general purpose computing platform (e.g. blade server), or as a software module extending a virtual hardware switch (VSWITCH) between virtual systems. When running on a general purpose computing platform, the software would typically be run in userspace along with userspace I/O device drivers.

The load balancing engine 210 is dynamically programmed at runtime (by one or more independent application programs, via the application interface 220) and can support multiple simultaneous independent load balancing scripts 250. The scripts 250 are executed in a prioritized fashion (e.g. as requested by the applications themselves and/or as assigned by the system). A single input packet may be run against multiple scripts; however, once a script decides to handle the packet (and subsequent related packets), the packet will not be processed by any additional lower priority scripts.

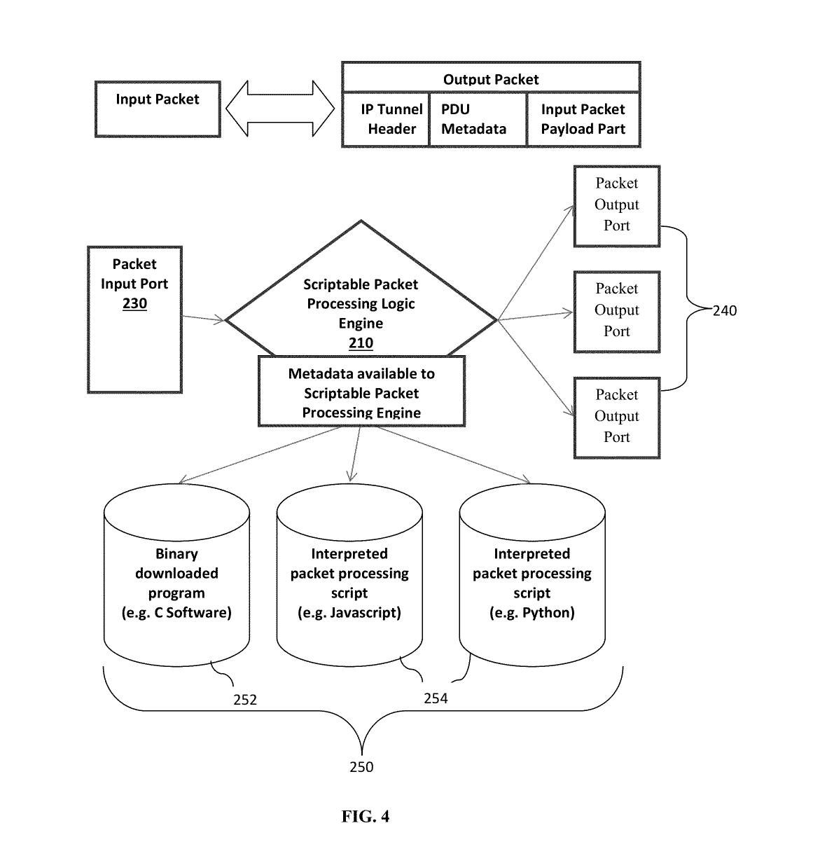

In some embodiments, an input packet that enters a packet input port 230 may be encapsulated by the dynamically scriptable load balancing engine 210 (FIG. 4). The input packet may be encapsulated in an IP packet (e.g. a UDP packet) along with metadata sent to an output port 240. The metadata may be associated with the input port 230 or with previous related input packets.

The load balancing scripts 250 can be defined in either a compiled language (e.g. software written in languages such as C or C#) or an interpreted scripting language such as Python, Java, or Javascript, or derivatives of scripted languages such as Cython and Jython. One advantage of using an interpreted language is that if a script is installed that contains a programming fault, the scriptable load balancer framework will catch the exception and recover gracefully without affecting other scripts or packets. For performance, a JIT (Just-in-time) compilation engine can be applied to optimize the interpreted scripts. A second advantage is that these scripts can work across all ranges of devices that support this feature without any changes to the interpreted scripts. Binary compiled programs do not offer this advantage and must often be recompiled for different hardware devices. Any hardware or software device that supports the interpreted scripting language would be able to use the script without change regardless of the underlying hardware. A third advantage is that these interpreted scripts are often easier for application developers to write, providing application developers with a resource to develop network scripts that run on devices they commonly cannot program.

Accordingly, the following are some examples of services that can be provided by scripts running in the load balancing engine 210:
Perform protocol decoding of a packet arriving on an input port, perform lookups in existing state tables, update state tables, modify the packet by adding/removing/updating headers or the packet payload, and then forward the resulting packet to an output port
Monitor an application server/host in the load balancer pool
Collect various statistics for export
Perform protocol-specific load balancing (e.g. GTP-C decoding) and tunneling of traffic for subsequent processing
Perform policy-based IP forwarding
Apply a packet-filtering operation
Perform IP-reassembly

Various features and advantages of the invention are set forth in the following claims.

What is claimed is:

1. A dynamically-scriptable load balancer, comprising:
a packet input port;
a packet output port;
a dynamically scriptable load balancing engine; and
an application interface for loading a load balancing script into the dynamically scriptable load balancing engine.

2. The dynamically-scriptable load balancer of claim 1, wherein one or more load balancing scripts are loaded into the load balancing engine at run time.

3. The dynamically-scriptable load balancer of claim 1, wherein the load balancing script is written in an interpreted language and wherein the dynamically scriptable load balancing engine comprises a script interpreter.

4. The dynamically-scriptable load balancer of claim 3, wherein, if the load balancing script contains a programming fault, the script interpreter of the dynamically scriptable load balancing engine terminates the load balancing script or provides an exception handler to continue processing the script in a manner that allows the script to continue executing.

5. The dynamically-scriptable load balancer of claim 3, wherein the dynamically scriptable load balancing engine further comprises a just in time compilation engine and wherein the just in time compilation engine is used to optimize the load balancing script.

6. The dynamically-scriptable load balancer of claim 1, wherein packets enter a packet input port that is part of a Link Aggregation Group (LAG).

7. The dynamically-scriptable load balancer of claim 1, wherein packets enter a packet input port that is optionally part of a Link Aggregation Group (LAG) and are sent to an output port that is part of a Link Aggregation Group (LAG).

8. The dynamically-scriptable load balancer of claim 1, wherein an input packet enters a packet input port and the dynamically scriptable load balancing engine encapsulates the input packet in an IP packet along with metadata and sends the packet to an output port.

9. The dynamically-scriptable load balancer of claim 8, wherein the metadata is associated with the input port or previous related input packets.

10. The dynamically-scriptable load balancer of claim 9, wherein the IP packet comprises a UDP packet.

11. The dynamically-scriptable load balancer of claim 1, wherein the load balancing script is a binary executable program.

12. The dynamically-scriptable load balancer of claim 1, wherein the dynamically scriptable load balancing engine processes scripts in a prioritized fashion.

13. The dynamically-scriptable load balancer of claim 1, wherein the dynamically scriptable load balancing engine is added to a forwarding plane of the dynamically-scriptable load balancer.

14. The dynamically-scriptable load balancer of claim 1, wherein the load balancing script comprises an arbitrary list of instructions.

15. The dynamically-scriptable load balancer of claim 1, further comprising memory accessible to the dynamically scriptable load balancing engine.

16. A method for dynamically controlling a load balancer, the method comprising:
providing a dynamically-scriptable load balancer having a packet input port, a packet output port, a dynamically scriptable load balancing engine, and an application interface; and
loading a load balancing script into the scriptable load balancing engine through the application interface.

17. The method of claim 16, further comprising loading a load balancing script into the scriptable load balancing engine through the application interface at run time.

18. The method of claim 16, wherein the load balancing script is written in an interpreted language and wherein the dynamically scriptable load balancing engine comprises a script interpreter.

19. The method of claim 18, further comprising, if the load balancing script contains a programming fault, the script interpreter of the dynamically scriptable load balancing engine terminating the load balancing script or providing an exception handler to continue processing the script in a manner that allows the script to continue executing.

20. The method of claim 18, wherein the dynamically scriptable load balancing engine further comprises a just in time compilation engine, the method further comprising the just in time compilation engine optimizing the load balancing script.

21. The method of claim 16, wherein packets enter a packet input port that is part of a link aggregation group (LAG).

22. The method of claim 16, wherein packets enter a packet input port that is optionally part of a link aggregation group (LAG) and are sent to an output port that is part of a link aggregation group (LAG).

23. The method of claim 16, further comprising the dynamically scriptable load balancing engine encapsulating an input packet in an IP packet along with metadata and sending the packet to an output port.

24. The method of claim 23, wherein the metadata is associated with the input port or previous related input packets.

25. The method of claim 24, wherein the IP packet comprises a UDP packet.

26. The method of claim 16, wherein the load balancing script is a binary executable program.

27. The method of claim 16, further comprising the dynamically scriptable load balancing engine processing scripts in a prioritized fashion.

28. The method of claim 16, wherein the dynamically scriptable load balancing engine is added to a forwarding plane of the dynamically-scriptable load balancer.

29. The method of claim 16, wherein the load balancing script comprises an arbitrary list of instructions.

30. The method of claim 16, wherein the load balancer further comprises memory accessible to the dynamically scriptable load balancing engine.

31. A system for dynamically controlling a load balancer, comprising:
a dynamically-scriptable load balancer comprising
a packet input port,
a packet output port,
a dynamically scriptable load balancing engine,
an application interface, and
a controller in communication with the packet input port, the packet output port, the dynamically scriptable load balancing engine, and the application interface, the controller being configured to load a load balancing script into the scriptable load balancing engine through the application interface.

32. The system of claim 31, wherein the controller is further configured to load a load balancing script into the scriptable load balancing engine through the application interface at run time.

33. The system of claim 31, wherein the load balancing script is written in an interpreted language and wherein the dynamically scriptable load balancing engine comprises a script interpreter.

34. The system of claim 33, wherein the controller is further configured to, if the load balancing script contains a programming fault, instruct the script interpreter of the dynamically scriptable load balancing engine to terminate the load balancing script or provide an exception handler to continue processing the script in a manner that allows the script to continue executing.

35. The system of claim 33, wherein the dynamically scriptable load balancing engine further comprises a just in time compilation engine, wherein the controller is further configured to optimize the load balancing script using the just in time compilation engine.

36. The system of claim 31, wherein packets enter a packet input port that is part of a link aggregation group (LAG).

37. The system of claim 31, wherein packets enter a packet input port that is optionally part of a link aggregation group (LAG) and are sent to an output port that is part of a link aggregation group (LAG).

38. The system of claim 31, wherein an input packet enters a packet input port and the dynamically scriptable load balancing engine encapsulates the input packet in an IP packet along with metadata and sends the packet to an output port.

39. The system of claim 38, wherein the metadata is associated with the input port or previous related input packets.

40. The system of claim 39, wherein the IP packet comprises a UDP packet.

41. The system of claim 31, wherein the load balancing script is a binary executable program.

42. The system of claim 31, wherein the controller is further configured to instruct the dynamically scriptable load balancing engine to process scripts in a prioritized fashion.

43. The system of claim 31, wherein the dynamically scriptable load balancing engine is added to a forwarding plane of the dynamically-scriptable load balancer.

44. The system of claim 31, wherein the load balancing script comprises an arbitrary list of instructions.

45. The system of claim 31, wherein the load balancer further comprises memory in communication with the controller and accessible to the dynamically scriptable load balancing engine.
